(19) United States
(12) Patent Application Publication
(10) Pub. No.: US 2026/0274188 A1
(43) Pub. Date: Sep. 17, 2026

(54) KNEE PROTECTOR

(71) Applicants: Nissan Motor Co., Ltd., Yokohama-shi (JP); ASTEER CO., LTD., Soja-shi (JP)

(72) Inventors: Ryuuichi USUI, Kanagawa (JP); Shigeo OTSUKA, Okayama (JP); Koji SHIMOTSU, Okayama (JP); Ryuto TACHIBANA, Okayama (JP)

(21) Appl. No.: 19/558,674

(22) Filed: Mar. 6, 2026

(30) Foreign Application Priority Data
Mar. 12, 2025 (JP) 2025-039576

(51) Int. Cl. B60R 21/045; B60R 21/055; B60R 21/00

(52) U.S. Cl. CPC B60R 21/045; B60R 21/055; B60R 2021/0051

(57) ABSTRACT

A knee protector mounted to a structural vehicle body member includes a first portion, a second portion, and a third portion. The first portion extends rearwardly from the structural vehicle body member. The second portion extends rearwardly from a rear end of the first portion and has a lower rigidity in a vehicle front-rear direction than the first portion. The third portion is secured to a rear end of the second portion only at an upper portion of the third portion and extends downwardly from the upper portion. A rearward surface of the third portion extends from the upper portion to a lower portion of the third portion and is disposed to form a load input surface to which a load from an occupant's knee is input.

### CROSS REFERENCE TO RELATED APPLICATIONS

This application claims priority under 35 U.S.C. § 119 to Japanese Patent Application No. 2025-039576 filed on Mar. 12, 2025, the entire disclosure of Japanese Patent Application No. 2025-039576 is hereby incorporated herein by reference.

### BACKGROUND

### Technical Field

The disclosure relates to a knee protector.

### Background Information

JP2002-326550 A discloses a structure of a knee bolster for reducing the load acting on the knee of an occupant during a vehicle collision.

### SUMMARY

The height of the knee of an occupant varies depending on the physique of the occupant, and an occupant with a large physique generally has a higher knee position and a heavier body weight, so that it is necessary to increase the reaction force on the knee during a vehicle collision. In contrast, an occupant with a small physique has a lower knee position and a lighter body weight, so that it is necessary to reduce the reaction force on the knee to a certain degree during a vehicle collision. Since the knee bolster of JP2002-326550 A includes an upper stay and a lower stay which support an upper portion and a lower portion of the panel, respectively, the reaction force on the knee may be inappropriately large for an occupant with a small physique during a vehicle collision.

An object of the present disclosure is to provide a knee protector capable of applying a relatively large reaction force to the knee of an occupant with a large physique and a relatively small reaction force to the knee of an occupant with a small physique during a vehicle collision.

A knee protector according to one aspect of the present disclosure is mounted to a structural vehicle body member, and includes: a first portion extending rearwardly from the structural vehicle body member; a second portion extending rearwardly from a rear end of the first portion and having lower rigidity in a vehicle front-rear direction than the first portion; and a third portion secured to a rear end of the second portion only at an upper portion of the third portion and extending downwardly from the upper portion, in which a rearward surface of the third portion extending from the upper portion to a lower portion of the third portion, is disposed to form a load input surface to which a load from an occupant's knee is input.

### BRIEF DESCRIPTION OF DRAWINGS

Referring now to the attached drawings which form a part of this original disclosure, illustrated embodiments are shown.

FIG. 1 is a side view illustrating the structure of a knee protector according to an embodiment.

FIG. 2 is a perspective view illustrating the structure of the knee protector.

FIG. 3 is a perspective view illustrating the structure of the knee protector.

FIG. 4A is a side view illustrating a knee position of an occupant with a relatively large physique at the start of load input to a load input surface of the knee protector during a vehicle collision.

FIG. 4B is a side view illustrating the knee protector deformed by a load applied from the knee of the occupant with the relatively large physique during the vehicle collision.

FIG. 4C is a side view illustrating a knee position of an occupant with a relatively small physique at the start of load input to a load input surface of the knee protector during a vehicle collision.

FIG. 4D is a side view illustrating the knee protector deformed by a load applied from the knee of the occupant with the relatively small physique during the vehicle collision.

### DETAILED DESCRIPTION OF EMBODIMENTS

Hereinafter, a knee protector according to an embodiment will be described with reference to the drawings. In the following description, frontward and rearward in the vehicle front-rear direction, upward and downward in the vehicle up-down direction, and the left side and right side in the vehicle width direction will hereinafter be simply referred to as frontward, rearward, upward, downward, the left side and right side, respectively. In addition, the configurations having the same functions as those already described will be denoted by the same reference numerals, and the descriptions thereof will be omitted. Hereinafter, the structure of the knee protector disposed on the right side of the vehicle will be described by way of example. Since the structure of the knee protector disposed on the left side of the vehicle is the same as or similar to that on the right side, the description thereof will be omitted.

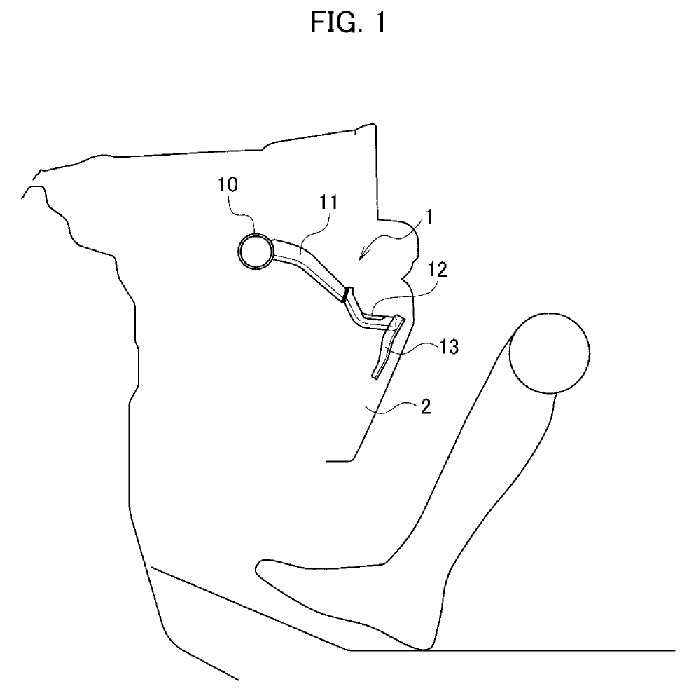

As illustrated in FIGS. 1 to 4D, a knee protector 1 is mounted to and supported by a structural vehicle body member 10. The knee protector 1 includes a first portion 11, a second portion 12 extending rearwardly from the first portion 11, and a third portion 13 fixed to the second portion 12 and extending downwardly.

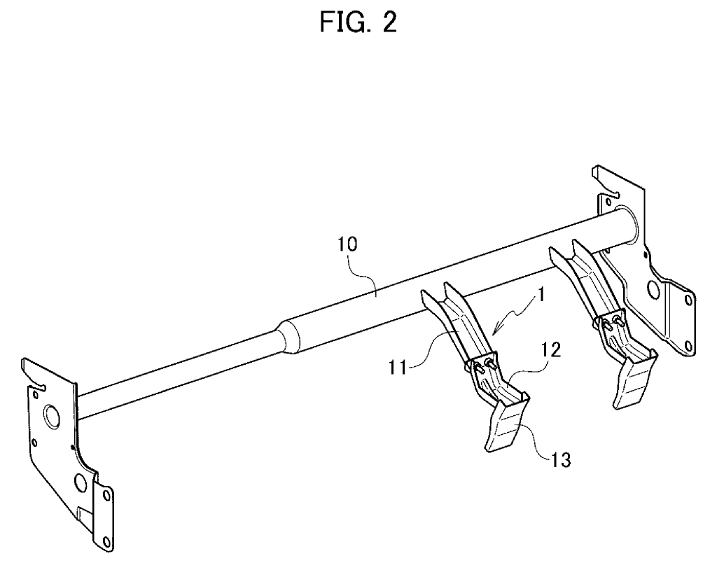

As illustrated in FIGS. 1 to 4D, the knee protector 1 is supported by the structural vehicle body member 10 provided in front of the knee protector 1. As illustrated in FIG. 1, the knee protector 1 is covered with an instrument panel 2 provided at the rear of the knee protector 1. The knee protector 1 is a member for suppressing a load acting on the occupant's knee when the occupant's knee collides with the instrument panel 2 positioned in front of the occupant's knee during the vehicle collision. As illustrated in FIG. 2, left and right knee protectors 1 are provided so as to be positioned opposite to the left knee and the right knee of the occupant, respectively. In the following description, of the pair of left and right knee protectors 1, the structure of the left knee protector 1 will be described. Since the right knee protector 1 has the same or similar structure, the description thereof will be omitted.

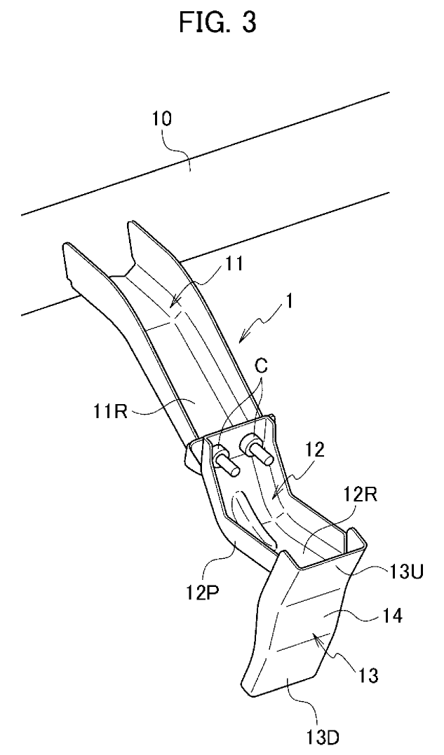

The structural vehicle body member 10 is a steering member, for example. The steering member extends substantially horizontally in the vehicle width direction and is coupled to, for example, the left and right frames (not illustrated) of the vehicle body. As illustrated in FIG. 1, the first portion 11 has the front portion coupled to the structural vehicle body member 10 and extends rearwardly, inclining downwardly from the front portion. The first portion 11 is formed of metal and has flanges extending upwardly on the left and right sides of the first portion 11, as illustrated in FIGS. 2 and 3. That is, the first portion 11 has a substantially U-shaped structure opening upward in a cross section perpendicular to the extending direction of the first portion 11.

As illustrated in FIG. 3, the second portion 12 is coupled to the rear end 11R of the first portion 11 and extends rearwardly from the rear end 11R. As illustrated in FIG. 3, the second portion 12 has the front portion fixed to the rear end 11R of the first portion 11 at two fixed points C arranged in parallel in the vehicle width direction. The second portion 12 is fixedly fastened to the rear end 11R of the first portion 11 with bolts and nuts.

The second portion 12 has a lower rigidity in the vehicle front-rear direction than the first portion 11. The second portion 12 is made of metal and has flanges extending upwardly on the left and right sides of the second portion 12, as illustrated in FIGS. 2 and 3. That is, the second portion 12 has a substantially U-shaped structure opening upward in a cross section perpendicular to the extending direction of the second portion 12.

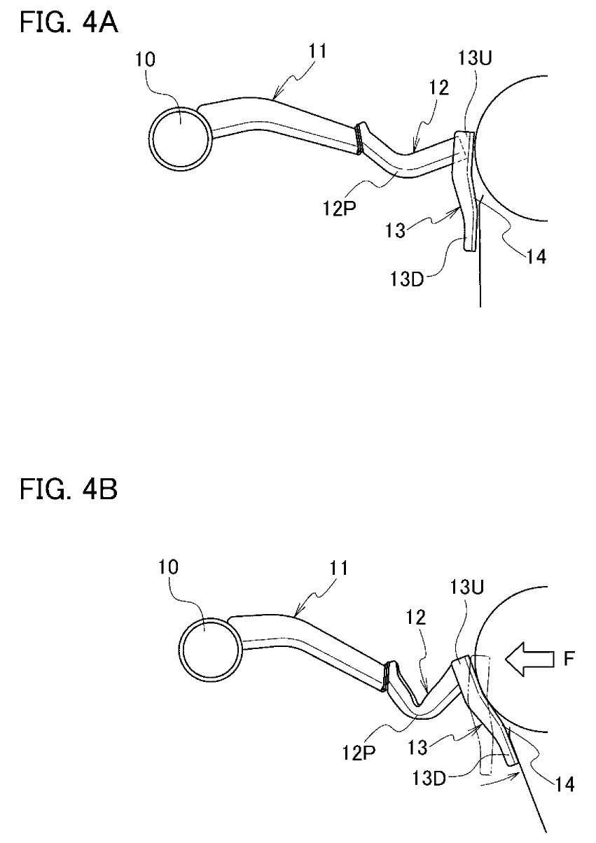

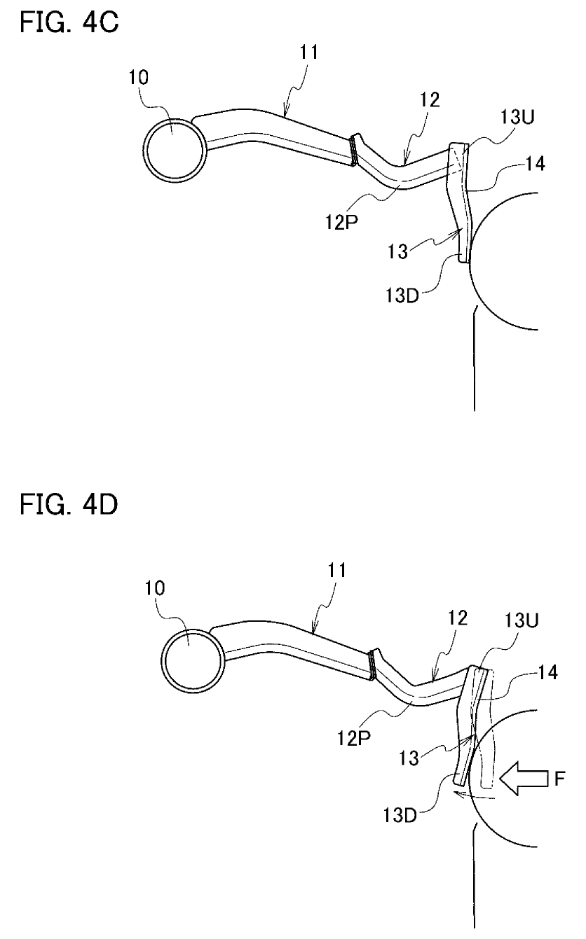

As illustrated in FIGS. 1 to 4D, the second portion 12 is bent in the up-down direction. As illustrated in FIGS. 3 to 4D, the second portion 12 has a bent portion 12P that is bent in the up-down direction. That is, in the structure illustrated in FIGS. 1 to 4D, the second portion 12 is bent around an axis parallel to the vehicle width direction. More specifically, as illustrated in FIGS. 3 to 4D, the second portion 12 extends to the bent portion 12P, inclining downwardly from the rear end 11R of the first portion 11. Further, the second portion 12 extends rearwardly, inclining upwardly from the bent portion 12P. In other words, the second portion 12 is formed in a substantially V-shape opening upward at the bent portion 12P as a bend point in side view. Therefore, the second portion 12 has a relatively lower rigidity in the vehicle front-rear direction than the first portion 11. Note that the means for reducing the rigidity of the second portion 12 in the vehicle front-rear direction is not limited to the above. For example, the second portion 12 may have a smaller cross-sectional shape than the first portion 11, or may be made of a material with lower rigidity or have a thickness thinner than the first portion 11.

As illustrated in FIG. 3, the upper portion 13U of the third portion 13 is fixed to and supported by the rear end 12R of the second portion 12. Further, as illustrated in FIGS. 3 to 4D, the third portion 13 extends downwardly from the upper portion 13U. Of the third portion 13, only the upper portion 13U is fixed to and supported by the rear end 12R of the second portion 12. That is, the third portion 13 has a panel shape and is cantilevered with the upper portion 13U as a fixed end and the lower portion 13D as a free end. As illustrated in FIG. 3, the rearward surface of the third portion 13 facing rearwardly in the vehicle front-rear direction, extends from the lower portion 13D of the third portion 13 to the upper portion 13U. The rearward surface serves as a load input surface 14 to which a load from the occupant's knee is input during a vehicle collision. The upper portion 13U of the third portion 13 according to the embodiment is fixedly welded to the rear end 12R of the second portion 12.

As illustrated in FIG. 3, the second portion 12 is detachably connected to the rear end 11R of the first portion 11. That is, the first portion 11 and the second portion 12 are configured as separate components, and the second portion 12 is fixedly connected to the rear end 11R of the first portion 11. Therefore, during the vehicle assembly, the first portion 11 can first be installed on the structural vehicle body member 10 before performing predetermined assembly operations, and the second portion 12 can be fixed to and installed on the first portion 11 after performing the predetermined assembly operations. At this time, the third portion 13 may be connected to the second portion 12, and the second portion 12 with the third portion 13 connected thereto may be fixedly installed on the first portion 11.

A deformation mode of the knee protector 1 during a vehicle collision will be described. As illustrated in FIG. 4A, when the occupant has a relatively large physique, the position of the occupant's knee with respect to the load input surface 14 is high. For this reason, the occupant's knee is positioned in the vicinity of the upper portion 13U of the third portion 13 in the load input surface 14 during a vehicle collision. Therefore, the load F from the occupant's knee is input to the vicinity of the upper portion 13U. Accordingly, the load is also input to the second portion 12 connected to the upper portion 13U. Since the rigidity of the second portion 12 in the vehicle front-rear direction is lower than that of the first portion 11, the second portion 12 deforms to a greater extent than the first portion 11 to absorb the collision energy, as illustrated in FIG. 4B. At this time, a relatively large reaction force is generated and applied to the occupant's knee. More specifically, in this case, the second portion 12 deforms so as to collapse in the front-rear direction, with the bent portion 12P as a starting point, and the second portion 12 functions as a shock absorber. Further, as illustrated in FIG. 4B, the upper portion 13U of the third portion 13 is displaced frontwardly by the load F, and the lower portion 13D is rotated rearwardly, thereby protecting the occupant's knee and tibia.

As illustrated in FIG. 4C, when the occupant has a relatively small physique, the position of the occupant's knee with respect to the load input surface 14 is low. For this reason, the occupant's knee is positioned in the vicinity of the lower portion 13D of the third portion 13 in the load input surface 14 during a vehicle collision. Therefore, the load F from the occupant's knee is input to the vicinity of the lower portion 13D. At this time, since the third portion 13 is cantilevered with the upper portion 13U as a fixed end, the lower portion 13D of the third portion 13 is displaced frontwardly by the load F to absorb the collision energy, as illustrated in FIG. 4D. At this time, a relatively small reaction force is generated and applied to the occupant's knee, thereby protecting the occupant's knee and tibia. In this case, the load is also input to the upper portion 13U of the third portion 13 and the second portion 12 that is connected to the upper portion 13U. However, since most of the collision energy is absorbed through the displacement of the lower portion 13D of the third portion 13, the upper portion 13U of the third portion 13 and the second portion 12 are displaced and deformed only to a relatively small extent.

(1) In the embodiment, the knee protector 1 is mounted to the structural vehicle body member 10 and includes: the first portion 11 extending rearwardly from the structural vehicle body member 10; the second portion 12 extending rearwardly from the rear end 11R of the first portion 11 and having lower rigidity in the vehicle front-rear direction than the first portion 11; and the third portion 13 secured to the rear end 12R of the second portion 12 only at the upper portion 13U thereof and extending downwardly from the upper portion 13U, in which the vehicle-rearward surface of the third portion 13 extending from the upper portion 13U to the lower portion 13D, is disposed to form the load input surface 14 to which a load from the occupant's knee is input.

When the occupant has a relatively large physique, the position of the occupant's knee with respect to the load input surface 14 is high. For this reason, the occupant's knee is positioned in the vicinity of the upper portion 13U of the third portion 13 in the load input surface 14 during a vehicle collision. Therefore, the load F from the occupant's knee is input to the vicinity of the upper portion 13U. At this time, the second portion 12 deforms to a greater extent than the first portion 11 to absorb the collision energy, thereby generating a relatively large reaction force on the occupant's knee. In contrast, when the occupant has a relatively small physique, the position of the occupant's knee with respect to the load input surface 14 is low. For this reason, the load F from the occupant's knee is input to the vicinity of the lower portion 13D during a vehicle collision. At this time, the lower portion 13D of the third portion 13 is displaced frontwardly by the load F to absorb the collision energy, thereby generating a relatively small reaction force on the occupant's knee. That is, according to the above configuration, the knee protector can apply a relatively large reaction force to the knee of an occupant with a large physique and a relatively small reaction force to the knee of an occupant with a small physique during a vehicle collision.

(2) In the embodiment, the second portion 12 is bent in the up-down direction. Thus, when the load F from the occupant's knee is input to the load input surface 14 during a vehicle collision, the second portion 12 is bent in the up-down direction and deformed so as to collapse in the front-rear direction. Therefore, the above configuration makes it possible to appropriately absorb the collision energy during a vehicle collision.

(3) Further, in the embodiment, the second portion 12 is detachably connected to the rear end 11R of the first portion 11. That is, the first portion 11 and the second portion 12 are configured as separate components, and the second portion 12 is fixedly connected to the rear end 11R of the first portion 11. Therefore, during the vehicle assembly, the first portion 11 can first be installed on the structural vehicle body member 10 before performing predetermined assembly operations, and the second portion 12 can be fixedly installed on the first portion 11 after performing the predetermined assembly operations. When the first portion 11 and the second portion 12 are configured as integral components, the second portion 12 is installed simultaneously at the rear of the first portion 11 during the vehicle assembly, so that a space for performing the predetermined assembly operations at the front section of the vehicle is restricted. Therefore, the above configuration improves the workability during the vehicle assembly compared to when the first portion 11 and the second portion 12 are configured as integral components.

While an embodiment has been described, the embodiment has been presented by way of example only, and are not intended to limit the scope of the invention. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the invention.

1. A knee protector mounted to a structural vehicle body member, the knee protector comprising:
a first portion extending rearwardly from the structural vehicle body member;
a second portion extending rearwardly from a rear end of the first portion and having lower rigidity in a vehicle front-rear direction than the first portion; and
a third portion secured to a rear end of the second portion only at an upper portion of the third portion and extending downwardly from the upper portion, wherein
a rearward surface of the third portion extending from the upper portion to a lower portion of the third portion disposed to form a load input surface to which a load from an occupant's knee is input.

2. The knee protector according to claim 1, wherein
the second portion is bent in an up-down direction.

3. The knee protector according to claim 1, wherein
the second portion is detachably connected to the rear end of the first portion.
